(19) United States
(12) Patent Application Publication
(10) Pub. No.: US 2024/0125186 A1
(43) Pub. Date: Apr. 18, 2024

(54) Drill Pipe with Integral Upset

(71) Applicant: Sophia Oilfield Supply Services, LLC, Houston, TX (US)

(72) Inventor: Salvatore Mangione, Houston, TX (US)

(21) Appl. No.: 18/487,552

(22) Filed: Oct. 16, 2023

Related U.S. Application Data
(60) Provisional application No. 63/416,082, filed on Oct. 14, 2022.

(51) Int. Cl. E21B 17/10; B23K 31/02

(52) U.S. Cl. CPC E21B 17/1085; B23K 31/02

(57) ABSTRACT

A drill pipe having a cylindrical body, a pin end, a box end, and a central wear pad. The central wear pad is integrally formed on the body and has an outside diameter greater than that of the cylindrical body, but less than those of the pin and box ends.

### CROSS REFERENCE TO RELATED APPLICATION

This application claims priority to U.S. Application No. 63/416,082 filed on Oct. 14, 2022, the disclosure of which is incorporated herein by reference for all purposes.

### FIELD OF THE INVENTION

The present invention relates to drill pipe, more particularly to drill pipe with an integral upset.

### BACKGROUND OF THE INVENTION

Wear pads are often employed to protect drill pipe from the friction and wear encountered during drilling, particularly directional drilling. Wear pads can be removably clamped or otherwise attached to the outside of drill pipe. Alternatively wear pads can be integrally formed as part of the drill pipe.

### SUMMARY OF THE INVENTION

In one aspect, the present invention relates to a drill pipe having an integrally formed central wear pad.

In another aspect, the present invention relates to a method of making a drill pipe having an integrally formed central wear pad.

These and further features and advantages of the present invention will become apparent from the following detailed description, wherein reference is made to the FIGURES in the accompanying drawings.

### BRIEF DESCRIPTION OF THE DRAWINGS

FIG. 1 depicts one embodiment of the drill pipe of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

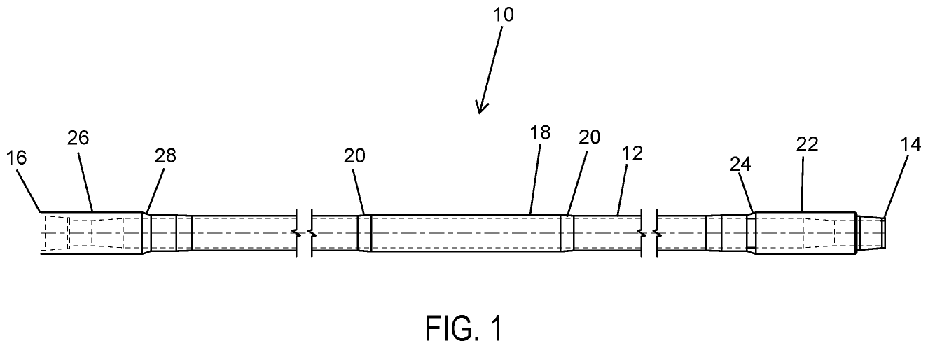

Turning to FIG. 1 there is shown generally as 10 one embodiment of the drill pipe of the present invention. Drill pipe 10 comprises cylindrical body 12 having a pin end 14 and a box end 16. A wear pad 18 is positioned generally centrally between pin end 14 and box end 16. Wear pad 18 has tapered portions 20. A pin upset portion 22 is disposed proximate pin end 14. Pin upset 22 includes a tapered portion 24. A box upset portion 26 is disposed proximate box end 16. Box upset 26 includes tapered portion 28.

In a preferred embodiment the outside diameter (OD) of wear pad 18 is greater than the OD of body 12 and less than the ODs of pin upset 22 and box upset 22. Additionally, the angle of tapered portions 20 is preferably less than the angles of tapered portions 24 and 28.

The length of wear pad 18 can be from about 25 to about 35 inches, preferably about 28 to about 32 inches, more preferably about 30 inches. The angle of tapered portions 20 can be from about 1° to about 10°, preferably from about 3° to about 7°, more preferably from about 4° to about 6°, most preferably about 5°. The cross-sectional thickness of wear pad 18 can be from about 0.500 to about 0.750 inches, preferably from about 0.600 to about 0.700 inches, most preferably about 0.625 inches.

By way of example only, and without limitation to the scope of the invention, FIG. 1 depicts a drill pipe body having an OD of 5.5 inches. Wear pad 18 is 30 inches long (not including the tapered portions 20) and has an OD of 5.875 inches, the wear pad itself being only 0.625 inches thick. Pin and box upsets 22 and 24, respectively, each have ODs of 6.625 inches. Thus, the OD of wear pad 18 is greater than that of the cylindrical body 12 and less than that of the pin and box upsets 22 and 24.

In other examples, the OD of drill pipe body may be 4, 4.5, or 5 inches.

The drill pipe 10 of the present invention has a wear pad which is longer and thinner than typical prior art wear pads. For example, U.S. Pat. No. 8,783,344, incorporated herein by reference for all purposes, recites that the external diameter of the wear pad is at least 0.500 inches greater than the diameter of the drill pipe body, the thickness of the wear pad may range from about 1.000 to about 1.500 inches, and the length (excluding the tapered regions) is about 2.000 to about 24.000 inches. In the embodiment of the present invention depicted in FIG. 1, the wear pad external diameter is only 0.375 inches thicker than that of the drill pipe body, the thickness is only 0.625 inches, and the length (excluding the tapered regions) is 30 inches. Accordingly, the wear pad depicted in FIG. 1 is generally longer and thinner than that of the prior art.

To manufacture drill pipe 10, the exterior of a cylindrical drill pipe is machined to form the cylindrical body 12 and wear pad 18. Wear pad 18 is thus integrally formed on the drill pipe body. In a preferred embodiment the machining is done through a turning or a grinding process, more preferably a turning process. By using a machining process, rather than a forging process, there is no heat required and no metallurgical changes imparted to the metal. Forging processes impart heat to the metal and require extensive post-forging treatment to achieve the desired dimensions.

The pin and box tool joints are welded to opposite ends of body 12 to form the pin and box ends 14 and 16.

The drill pipe 10 of the present invention provides many advantages over the prior art. The wear pad 18 protects the drill pipe against various forces imparted during drilling processes. By using a thinner and longer wear pad as compared to the those in the prior art, the drill pipe achieved increased rigidity but is not so rigid as to be unbendable. The taper, length and integral nature of the wear pad enhance the resistance to fatigue stress cracking. Some bending is still achievable and the drill pipe of the present invention can be used in directional drilling. The drill pipe 10 is also resistant to buckling under weight.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A drill pipe, comprising:
a cylindrical body having an outside diameter (OD) pin end and a box end;
a central wear pad integrally formed on said cylindrical body and having a wear pad OD;
pin and box upsets disposed proximate the pin and box ends, respectively, said pin upset having a pin OD, and said box upset having a box OD;
the wear pad OD being less than the pin OD and box OD.

2. The drill pipe of claim 1, wherein the wear pad OD is greater than the OD of the cylindrical body.

3. The drill pipe of claim 1, wherein said central wear pad has first and second tapered portions, and wherein said pin and box upsets have a pin tapered portion and a box tapered portion, respectively;
the angle of said first and second tapered portions being less than the angles of said pin and box tapered portions.

4. The drill pipe of claim 3, wherein the angle of said first and second tapered portions is from about 1° to about 10°.

5. The drill pipe of claim 3, wherein the angle of said first and second tapered portions is from about 3° to about 7°.

6. The drill pipe of claim 3, wherein the angle of said first and second tapered portions is from about 4° to about 6°.

7. The drill pipe of claim 3, wherein the angle of said first and second tapered portions is about 5°.

8. The drill pipe of claim 1, wherein said central wear pad has a length of from about 25 inches to about 35 inches.

9. The drill pipe of claim 1, wherein said central wear pad has a length of from about 28 inches to about 32 inches.

10. The drill pipe of claim 1, wherein said central wear pad has a length of about 30 inches.

11. The drill pipe of claim 1, wherein said central wear pad has a thickness of from about 0.500 inches to about 0.750 inches.

12. The drill pipe of claim 1, wherein said central wear pad has a thickness of from about 0.600 inches to about 0.700 inches.

13. The drill pipe of claim 1, wherein said central wear pad has a thickness of about 0.625 inches.

14. A method of manufacturing the drill pipe of claim 1, comprising:
providing a cylindrical body having first and second ends,
machining said cylindrical body to form a central wear pad,
welding a pin end to said first end of said cylindrical body,
welding a box end to said second end of said cylindrical body.

15. The method of claim 14, wherein said machining comprises turning or grinding.
